(19) United States
(12) Patent Application Publication
(10) Pub. No.: US 2025/0254562 A1
(43) Pub. Date: Aug. 7, 2025

(54) DYNAMIC BUFFER STATUS REPORT SELECTION

(71) Applicant: Dell Products L.P., Round Rock, TX (US)

(72) Inventor: Ali Esswie, Calgary (CA)

(21) Appl. No.: 18/434,131

(22) Filed: Feb. 6, 2024

(51) Int. Cl. H04W 28/02; H04W 72/12

(52) U.S. Cl. CPC H04W 28/0278; H04W 72/12

(57) ABSTRACT

A radio access network node may configure a user equipment with multiple buffer status report tables. The node may transmit to the user equipment a buffer status reporting configuration comprising an indication of one or more of the configured tables that have been activated for use by the user equipment to generate buffer status reports. If the buffer status reporting configuration indicates that the node is implementing underscheduling of uplink resources in response to buffer status reports, the user equipment may select one or more of the activated configured tables that may result in a fewest number of transmissions of buffer status reports to obtain uplink resources to facilitate transmission of buffered traffic. The user equipment may transmit to the node one or more buffer status reports that each comprise a traffic volume index and a table indication indicative of a selected table corresponding to the traffic volume index.

### BACKGROUND

The ‘New Radio’ (NR) terminology that is associated with fifth generation mobile wireless communication systems (“5G”) refers to technical aspects used in wireless radio access networks (“RAN”) that comprise several quality-of-service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise receiving, by a user equipment comprising at least one processor from a radio access network node, a buffer status reporting configuration comprising an available table indication indicative of at least one buffer status report table usable by the user equipment to determine a buffer status report. The method may further comprise determining, by the user equipment, an amount of traffic, stored in a buffer corresponding to the user equipment, to be transmitted to the radio access network node to result in a determined amount of traffic. The method may further comprise determining, by the user equipment, at least one of the at least one buffer status report table to use to report the determined amount of traffic to the radio access network node to result in a determined at least one buffer status report table. The method may further comprise transmitting, by the user equipment to the radio access network node, at least one buffer status report comprising at least one buffered traffic amount indication that corresponds, in the determined at least one buffer status report table, to at least one subamount of the determined amount of traffic.

In an embodiment, the method may further comprise receiving, by the user equipment from the radio access network node, a buffer status report table configuration comprising the at least one buffer status report table. The method may further comprise storing, by the user equipment to a memory corresponding to the user equipment, the at least one buffer status report table.

In an embodiment, the buffer status report table configuration may comprise multiple buffer status report tables. The available table indication may be indicative of less than all of the multiple buffer status report tables.

The available table indication may be indicative of a first buffer status report table of the multiple buffer status report tables and a second buffer status report table of the multiple buffer status report tables. The method may further comprise determining that the radio access network node is implementing an underscheduling of uplink resources in response to receiving buffer status reports to result in a determined underscheduling. The determining of the at least one buffer status report table may comprise, based on the determined underscheduling, determining a first transmission number corresponding to use of the first buffer status report table to transmit at least one of the at least one buffer status report comprising the at least one buffered traffic amount indication that corresponds to the at least one subamount of the determined amount of traffic to result in a determined first transmission number. The determining of the at least one buffer status report table may comprise, based on the determined underscheduling, determining a second transmission number corresponding to use of the second buffer status report table to transmit at least one of the at least one buffer status report comprising the at least one buffered traffic amount indication that corresponds to the at least one subamount of the determined amount of traffic to result in a determined second transmission number. The determining of the at least one buffer status report table may comprise, determining a lower of the determined first transmission number or the determined second transmission number to result in a determined lowest transmission number. The determined at least one buffer status report table may be the first buffer status report table or the second buffer status report table that corresponds to the determined lowest transmission number.

The determining of the first transmission number may further comprise determining, from the first buffer status report table, a first traffic volume range index associated with a first traffic volume range that minimizes, based on the underscheduling, a first subamount remainder of the at least one subamount of the determined amount of traffic. The determining of the first transmission number may further comprise determining at least one first subamount remainder transmission number corresponding to use of the first buffer status report table to transmit at least one of the at least one buffer status report comprising the at least one buffered traffic amount indication that corresponds to the first subamount remainder of the determined amount of traffic to result in a determined first subamount transmission number, wherein the first transmission number equals one plus the determined first subamount transmission number. The determining the second transmission number may further comprise determining, from the second buffer status report table, a second traffic volume range index associated with a second traffic volume range that minimizes, based on the underscheduling, a second subamount remainder of the at least one subamount of the determined amount of traffic. The determining the second transmission number may further comprise determining at least one second subamount remainder transmission number corresponding to use of the second buffer status report table to transmit at least one of the at least one buffer status report comprising the at least one buffered traffic amount indication that corresponds to the second subamount remainder of the determined amount of traffic to result in a determined second subamount transmission number, wherein the second transmission number equals one plus the determined second subamount transmission number. The buffer status reporting configuration further comprises an underscheduling indication indicative of the underscheduling.

Based on a previous uplink resource grant of at least one uplink resource, granted by the radio access network node in response to receiving at least one previous buffer status report transmitted by the user equipment before the transmitting of the at least one buffer status report, the method may further comprise determining, by the user equipment, the underscheduling.

The at least one buffer status report may further comprise at least one table indication indicative of the determined at least one buffer status report table. The at least one subamount of the determined amount of traffic may equal the determined amount of traffic. The method may further comprise receiving, from the radio access network node, an activated table indication indicative of at least one of the at least one buffer status report table indicated by the available table indication.

In another example embodiment, a user equipment may comprise at least one processor configured to process executable instructions that, when executed by the processor, facilitate performance of operations, that may comprise receiving, from a radio access network node, a buffer status reporting configuration comprising at least one available table indication indicative of at least one buffer status report table usable by the user equipment to determine a buffer status report. The operations may further comprise receiving, from the radio access network node, a buffer status report table configuration comprising the at least one buffer status report table and storing, to a memory of the user equipment, the at least one buffer status report table. The operations further comprise determining an amount of traffic, stored in a buffer corresponding to the user equipment, to be transmitted to the radio access network node to result in a determined amount of traffic. The operations may further comprise determining that the radio access network node is underscheduling of uplink resources to result in a determined underscheduling. Based on the determined underscheduling, the operations may further comprise determining at least one of the at least one buffer status report table to use to report the determined amount of traffic to the radio access network node to result in a determined at least one buffer status report table. The operations may comprise transmitting, to the radio access network node, at least one buffer status report comprising at least one buffered traffic amount indication that corresponds, in the determined at least one buffer status report table, to the determined amount of traffic.

In an embodiment, the at least one buffer status report further comprises at least one table indication indicative of the determined at least one buffer status report table.

In an embodiment, the at least one buffered traffic amount indication that corresponds to the determined amount of traffic may comprise a first buffered traffic amount indication corresponding to a first traffic volume range in the determined at least one buffer status report table. The at least one buffered traffic amount indication that corresponds to the determined amount of traffic may further comprise a second buffered traffic amount indication corresponding to a second traffic volume range in the determined at least one buffer status report table. The at least one buffer status report may comprise a first buffer status report that comprises the first buffered traffic amount indication. The at least one buffer status report may further comprise a second buffer status report that comprises the second buffered traffic amount indication. The first traffic volume range may correspond to a determined first buffer status report table of the at least one buffer status report table. The second traffic volume range may correspond to a determined second buffer status report table of the at least one buffer status report table. The at least one buffer status report may comprise a first buffer status report that may comprise a first determined table indication indicative of the determined first buffer status report table. The at least one buffer status report may further comprise a second buffer status report that may comprise a second determined table indication indicative of the determined second buffer status report table.

In an embodiment, the at least one buffer status report table may comprise multiple buffer status report tables. The determining of the at least one of the at least one buffer status report table may comprise determining that use of the determined at least one buffer status report table corresponds to fewer transmissions of buffer status reports than use of other of the multiple buffer status report tables.

In yet another example embodiment, a non-transitory machine-readable medium may comprising executable instructions that, when executed by a processor of a user equipment, facilitate performance of operations that may comprise receiving, from a radio access network node, a buffer status reporting configuration comprising an available table indication indicative of multiple buffer status report tables usable by the user equipment to determine a buffer status report. The operations may comprise determining an amount of traffic, stored in a buffer corresponding to the user equipment, to be transmitted to the radio access network node to result in a determined amount of traffic. The methods may further comprise determining at least one of the multiple buffer status report tables to use for reporting the determined amount of traffic to the radio access network node that will result in a minimized number of buffer status reports being transmitted to the radio access network node to report the determined amount of traffic to result in a determined at least one buffer status report table. The method may further comprise transmitting, by the user equipment to the radio access network node, at least one buffer status report that comprises at least one buffered traffic amount indication that corresponds, in the determined at least one buffer status report table, to the determined amount of traffic and at least one table indication indicative of the determined at least one buffer status report table.

To determine the at least one of the multiple buffer status report tables that corresponds to the minimized number of buffer status reports being transmitted to the radio access network node, the operations may further comprise: for each table of the multiple buffer status report tables determining an initial traffic volume range that corresponds to a first lowest-traffic-volume-range that encompasses the determined amount of traffic to result in a determined initial lowest-traffic-volume-range and, based on uplink resource underscheduling by the radio access network node, determining a remainder amount of traffic. The operations may further comprise, for each table of the multiple buffer status report tables, determining at least one subsequent traffic volume range that corresponds to a second lowest-traffic-volume-range that encompasses the remainder amount of traffic to result in a determined at least one subsequent lowest-traffic-volume-range, and determining a number of traffic volume ranges based on the determined initial lowest-traffic-volume-range and the determined at least one subsequent lowest-traffic-volume-range. The operations may further comprise determining a lowest number of traffic volume ranges with respect to the multiple buffer status report tables. The at least one buffered traffic amount indication may comprise an initial buffered traffic amount indication indicative of the determined initial lowest traffic volume range. The at least one buffered traffic amount indication may comprise a subsequent buffered traffic amount indication indicative of the determined at least one subsequent lowest traffic volume range.

The at least one buffer status report may comprise a first buffer status report comprising the initial buffered traffic amount indication, wherein the at least one table indication is indicative of a first buffer status report table, of the multiple buffer status report tables, that comprises the determined initial lowest traffic volume range. The at least one buffer status report may comprise a second buffer status report comprising the subsequent buffered traffic amount indication, wherein the at least one table indication is indicative of a second buffer status report table of the multiple buffer status report tables that comprises the determined at least one subsequent lowest traffic volume range.

### BRIEF DESCRIPTION OF THE DRAWINGS

FIG. 1 illustrates wireless communication system environment.

FIG. 2 illustrates an example environment with a radio access network node transmits one or more buffer status reporting configurations to one or more user equipment.

FIG. 3 illustrates an example buffer status reporting configuration.

FIG. 4 illustrates example buffer status report tables.

FIG. 5 illustrates an example buffer status report.

FIG. 6 illustrates a timing diagram of an example method to provide a buffer status report to a serving radio access network node.

FIG. 7 illustrates a flow diagram of an example method to use a buffer status reporting configuration to determine and provide a buffer status report to a radio access network node.

FIG. 8 illustrates a block diagram of an example method.

FIG. 9 illustrates a block diagram of an example user equipment.

FIG. 10 illustrates a block diagram of an example non-transitory machine-readable medium.

FIG. 11 illustrates an example computer environment.

FIG. 12 illustrates a block diagram of an example wireless user equipment.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

The PDCCH of a 5G NR system may deliver downlink and uplink control information to cellular devices. Compared to the control channel design of the fourth generation (e.g., LTE), the 5G control channel can match requirements of the URLLC and eMBB use cases and can offer an efficient coexistence between those different QoS classes.

The 5G PDCCH channel, unlike the Fourth Generation control channel, may be beamformed using favored-channel vectors of each UE, with embedded demodulation-assisting demodulation reference signals (“DMRS”). The PDCCH may be modulated by a fixed QPSK modulation scheme and with a conservative coding rate such as the reliability of receiving the PDCCH channel at a UE device is maximized. For example, to satisfy a URLLC 10e-5 reliability level, the PDCCH channel decoding ability may be enhanced at the device end.

The resource size of each PDCCH channel, which may be carrying the downlink control information (“DCI”) of one or more UEs, may be time-varying, and may be referred to as PDCCH aggregation level. In particular, and to enhance PDCCH decoding, the network may increase the resource size of the PDCCH channel and accordingly adopt a more conservative and resource-less-efficient coding rate of the PDCCH. This implies that same amount of PDCCH control information is transmitted with a stronger coding rate (i.e., more redundant bits for error detection and correction) at the expense of consuming more channel resources for transmitting the PDCCH information.

There are two types of PDCCH channels. First, the UE-specific PDCCH, where a set channel resources are periodically monitored by a single UE/device. After being configured, the device will attempt to blindly decode those candidate resources in case they may be potentially carrying DCI information. This DCI information includes configurations on scheduled uplink or downlink grants, transmission configurations, and information on common system signaling and updates. Furthermore, the blind decoding is the process when the UE attempts decoding the DCI with all possible transmission configurations and aggregation levels. This implies a heavy power consumption on the device end; however, it is necessary because the UE is not yet aware about the actual configurations of the PDCCH channel and corresponding transmissions. It shall be aware of such after it successfully decodes the PDCCH. In the active mode, the UE may monitor the configured one or more PDCCH search spaces, where a search space implies a set of candidate resources that may carry the PDCCH/DCI information. The search space definitions may be used to refer to varying size of the PDCCH channel (i.e., aggregation levels) and hence, the required size of resources to carry the PDCCH may vary.

Common PDCCH search spaces are monitored by all UEs. Those common PDCCH channels typically carry DCI information that is relevant to all devices. Examples include system updates and control information, all-UE power control information, and general system information.

For each scheduled downlink or uplink transmission, there typically is a preceding PDCCH control transmission informing the UE device about resources scheduled by the network for the transmission, and transmission configurations to use for transmission in the uplink or reception in the downlink. Accordingly, the PDCCH transmissions are considered as signaling overhead, which should be always minimized, and needed for successful device transmission and/or reception.

A user equipment device (“UE”) with uplink traffic to be transmitted may transmit an uplink scheduling request (“SR”) over an uplink control channel between the user equipment and a radio access network node (“RAN”) that is serving the UE after establishing an initial connection with the network RAN. The SR transmission indicates to the RAN node vital information, such as the availability of uplink traffic at the device side so that the RAN can accordingly allocate a set of the available uplink resources that are appropriate to the UE for the uplink traffic to be transmitted therefrom. However, the network/RAN needs to be aware of the size, or amount, of the uplink traffic to be transmitted by the UE to allocate a suitable amount of uplink resources (e.g., scheduled uplink transmission occasions at a certain periodicity and at a certain frequency or within a certain frequency range). A buffer status report (“BSR”) transmitted from the UE to a RAN may convey to the RAN an amount of traffic to be transmitted by the UE.

Conventionally, a BSR report is transmitted from UE devices towards serving base stations (e.g., RANs), which BSR report includes information indicating a size, or amount, of uplink traffic buffered at devices. Buffer status reporting from devices towards serving cells, is important, since BSR reports indicate to a serving RAN the current buffered uplink traffic size of each device, and accordingly, the network can efficiently allocate the appropriate size of the uplink resources for those uplink traffic transmissions. To reduce the BSR reporting overhead (since it is needed for every uplink transmission), several buffered traffic size ranges are defined, where each is associated with a BSR integer index. Thus, user equipment devices may only transmit a BSR index that corresponds to the traffic range for which their buffered traffic size lies within.

To reduce the amount of BSR reporting overhead (e.g., uplink resources used for buffer status reporting instead of being used to transmit actual uplink traffic packets), the exact size of buffered uplink traffic is quantized into several predefined/configured size ranges and/or levels. Thus, a table of predefined BSR size ranges and associated BSR indexes is defined and configured in UE device, where each BSR index corresponds to a certain BSR range, (e.g., a certain size, or amount, of buffered uplink traffic in terms of bytes, for example).

However, a quantization step size between two successive buffered traffic size ranges represented by a BSR index may result in quantization error. Step sizes may be predefined and hard coded in fixed BSR tables that are broadcast to all user equipment devices, where step sizes corresponding to traffic volume ranges associated with one index to the next may be non-uniform. That is, a smaller fixed step size is typically used for smaller buffered traffic ranges and a larger step size is used for the larger traffic ranges. For instance, a single BSR index can indicate a buffered traffic range from 240 k bytes to 300 k bytes.

Spacing between the different quantization levels is typically non-uniform and is predefined, for example, a small quantization step size is used for ranges of smaller amounts of buffered uplink traffic and a larger step size may be used for ranges of larger amounts of buffered uplink traffic. Accordingly, conventional BSR reporting only includes an index from the table that corresponds to the current size of uplink traffic, which typically leads to a reduction in reporting overhead since an index value may comprise fewer bytes to be transmitted in an uplink reporting message than a number of bytes that may be transmitted to convey a value of an actual size of buffered uplink traffic.

However, due to the low resolution/low precision/coarseness of using large defined and configured step size values for large amounts of buffered uplink traffic at a UE, a RAN that receives a BSR based on a hard-coded range in a table stored on a UE may result in a RAN allocating enough uplink resources to accommodate an amount of uplink traffic buffered in a UE that is at the maximum value of a range even if the actual amount of buffered uplink traffic is at or near the low end of the configured hard-coded range that is associated with the BSR indication sent from the UE to the RAN. With extreme capacity and latency demanding 5G use cases, such as URLLC, VR, AR, etc., this may lead to extended scheduling latency and degraded network capacity. Because a network/RAN is not made aware of a refined/close-to-exact buffered traffic size of a UE device, the RAN may allocate a more-than-needed amount, or in some cases a less-than-needed amount of resources, for buffered uplink traffic. Accordingly, this results in allocation of uplink resources for non-existing uplink traffic or scheduling multiple instants for transmission of the buffered uplink traffic (which requires additional scheduling latency), leading to degraded spectral efficiency. Thus, such ‘under-allocation’ or ‘over-allocation’ for a given UE typically results in wasted network resources that could have been allocated or used for traffic corresponding to another UE device. Increasing the number of quantization levels (e.g., ranges) may reduce an amount of over-allocated or under-allocated resources but a set of index values that may be needed to represent the larger number of possible ranges may require more bytes to indicate a given index in an uplink BSR indication transmission, which also increases reporting overhead used for the BSR report. Therefore, dynamic BSR reporting that is adaptive with respect to an amount, or type, or uplink traffic buffered at a UE is desirable for efficient uplink transmissions, especially for capacity-demanding and latency-demanding use cases, where the buffered traffic size dynamically varies in time depending on the traffic flow, and type of associated quality of service (QOS) settings.

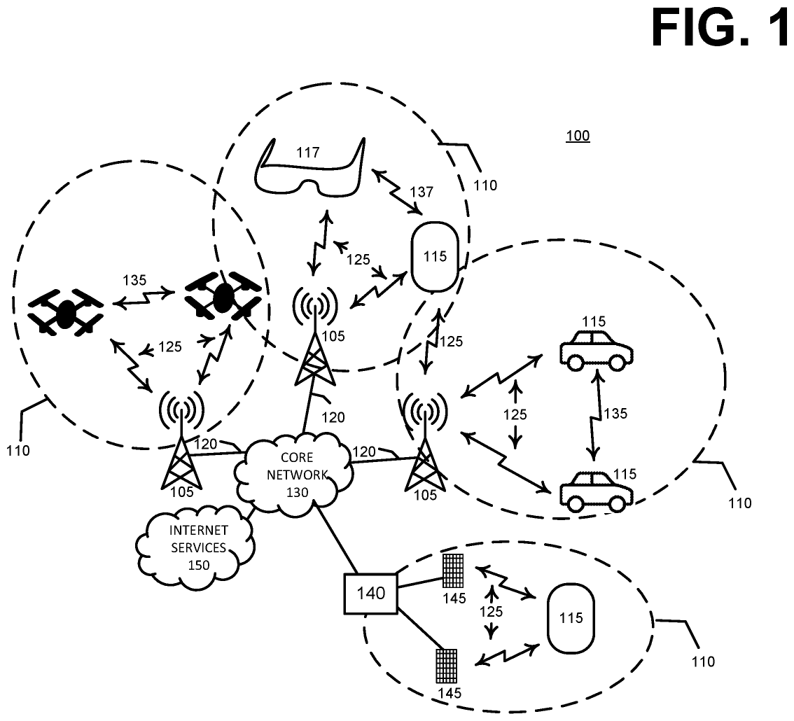

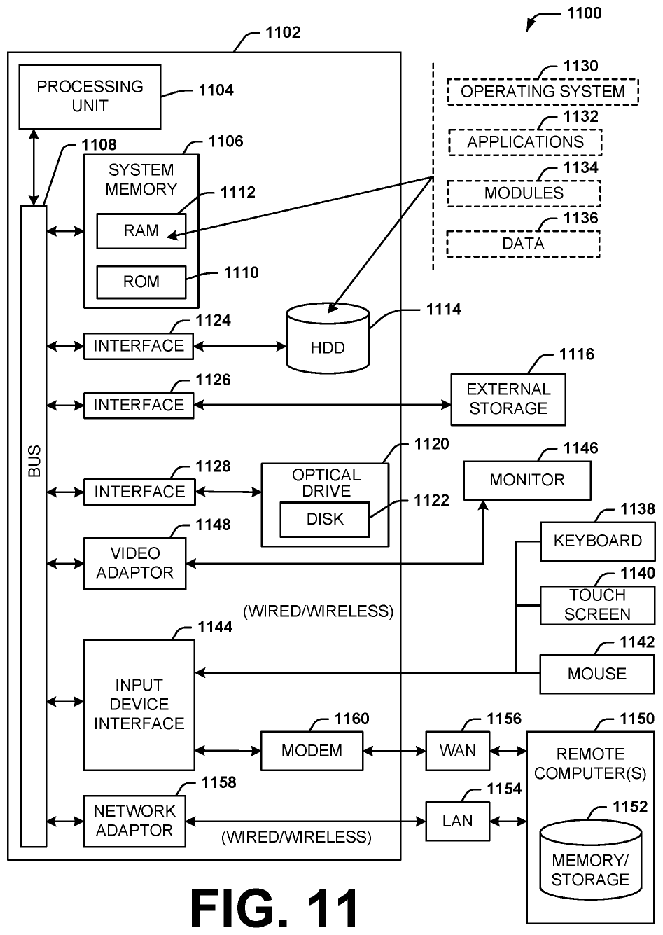

Turning now to the figures, FIG. 1 illustrates an example of a wireless communication system 100 that supports blind decoding of PDCCH candidates or search spaces in accordance with aspects of the present disclosure. The wireless communication system 100 may include one or more base stations 105, one or more UEs 115, and core network 130. In some examples, the wireless communication system 100 may be a Long Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality headset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 11.

Continuing with discussion of FIG. 1, base stations 105 may be dispersed throughout a geographic area to form the wireless communication system 100 and may be devices in different forms or having different capabilities. Base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 via one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHZ)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHZ.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHZ), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A 5G NR radio system typically comprises a physical downlink control channel (“PDCCH”), which may be used to deliver downlink and uplink control information to cellular devices. The 5G control channel may facilitate operation according to requirements of URLLC and eMBB use cases and may facilitate an efficient coexistence between such different QoS classes.

### Dynamic Buffer Status Report Selection.

Precision of a Buffer Status Report (“BSR”) quantization significantly impacts scheduling latency, and achievable device and network capacity. Enhancing quantization precision of a BSR, (e.g., smaller step size for determining index values that indicate to a RAN traffic to be transmitted by the user equipment), across all buffer size ranges with a fixed pattern is inefficient due to the time-varying characteristics of uplink traffic of each device class in 5G systems. For example, some user equipment devices may typically transmit a moderate amount of traffic packets while other user equipment devices may typically transmit a larger amount of traffic packets, (e.g., virtual reality traffic). Thus, a fixed step size for all user equipment devices, even if more precise/small than a step size corresponding to a less efficient BSR quantization, may not be optimal.

To improve uplink resource usage efficiency, as disclosed herein, a gNB, or RAN node, may dynamically configure each of multiple user equipment devices with multiple BSR tables, which may be specific to a particular user equipment. (It will be appreciated that the term ‘table’ may be used for purposes of illustration in the figures and that other forms of storing a configuration and using functions of the configuration may be used instead of a table.)

Buffer status reporting is radio procedure that facilitates active user equipment devices to periodically, or occasionally, report buffered uplink traffic volumes towards a serving RAN node. A RAN node receiving a BSR can schedule uplink resources that may facilitate a user equipment fully clearing traffic buffered in a buffer corresponding to the user equipment. BSR tables are typically designed to reduce signaling overhead used to transmit a BSR and BSR reporting is quantized to minimize an amount of data that a BSR comprises. For example, a user equipment typically reports a BSR index, corresponding to a traffic volume range in the BSR, that is indicative of an amount of uplink traffic buffered by the user equipment. For instance, a BSR index ‘50’ may be associated, in a BSR, with a traffic volume range of 100 to 150 Mbytes. Thus, a BSR indicating an index of ‘50’ may result in the BRS comprising fewer bits than if the BSR indicated an absolute amount of traffic, for example 102 Mbytes (e.g., the number ‘50’ can be represented by fewer bits than a number of bits that would be needed to represent 102 plus a number of bits needed to represent units of measure such as bytes, Kbytes, Mbytes, etc.). Although quantization may reduce a number of bits used to indicate buffered uplink traffic, the reduced BSR size may come expense of quantization errors, since a quantized index represents a range instead of an actual number of bytes buffered by a user equipment. Thus, a serving RAN node becomes aware not of an exact buffered traffic volume but of a traffic volume range, which may cause the RAN node to overschedule or underschedule uplink resources which may lead to reduced efficiency of uplink resource scheduling. For example, if a RAN node adopts underscheduling policies (e.g., scheduling just enough resources to accommodate a traffic volume equal to, or about the same as, a number corresponding to the low end of an uplink traffic volume range indicated by a BSR. Accordingly, if a serving RAN has adopted underscheduling, or is implementing underscheduling, to receive scheduling grants for uplink traffic buffered by a user equipment, the user equipment may transmit several buffer status reports if a value corresponding to an actual amount of buffered uplink traffic is between low and high ends of a range in a BSR table configured at the user equipment. Transmitting multiple uplink BSRs to obtain resource grants to clear buffered traffic may significantly increase uplink traffic delivery latency and use of BSR reporting overhead. (A best case is that a single BSR results a grant of enough uplink resources to transmit all buffered traffic and a next best scenario is that a very few BSRs are transmitted to a serving RAN to result in granting of enough uplink resources to clear the buffered traffic.)

Embodiments disclosed herein may facilitate avoiding BSR quantization error that may result in uplink capacity degradation by facilitating dynamic selection, by a user equipment, of one or more BSR table(s) and indices associated with traffic ranges indicted therein. Embodiments disclosed herein may be facilitated by a serving RAN node pre-defining one or more BSR tables with various traffic volume ranges and with corresponding indices. A RAN node may configure a user equipment with one or more of the BSR tables and may indicate to user equipment one or more of the configured BSR tables that are available to be used to generate a BSR. User equipment may determine one or more available tables to use for reporting buffered uplink traffic such that a number of BSR transmissions is minimized. By selecting a certain one or more available BSR tables, a user equipment may be able to clear its buffered traffic volume faster with minimized BSR reporting overhead used for transmission of BSRs. Thus, BSR uncertainty may be transferred to a serving RAN node, which typically comprises more processing flexibility than a user equipment device, while fast and precise BSR reporting by user equipment devices is facilitated. In an embodiment, a user equipment may determine a BSR table, or more than one BSR table, from a set of configured BSR tables, such that an expected number of transmissions of BSRs needed to report and responsively receive grants of uplink resources to facilitate transmission of buffered uplink traffic is minimized. The user equipment may determine the BSR table, or tables, based on an underscheduling, by a serving RAN node, of uplink resources.

A BSR may be used to indicate to a RAN node a current amount of uplink traffic size buffered by a user equipment. Based on the BSR, the RAN node may allocate an appropriate amount of uplink resources to facilitate uplink transmission of the buffered uplink traffic. To reduce overhead used for BSR reporting, a BSR table typically comprises several buffered traffic volume ranges, wherein each range may be associated with an index value, which may be referred to as a traffic volume range index. Thus, a user equipment may transmit a BSR that comprises only a BSR index that corresponds to a traffic volume range that encompasses a volume of uplink traffic buffered by the user equipment.

Although a conventionally determined BSR may facilitate reduction of resources used to report buffered uplink traffic, a quantization step size between two successive buffered traffic size ranges in a BSR table may result in a scheduling of resources that is not very well tuned to the actual amount of buffered uplink traffic if traffic volume ranges in a BSR table are predefined and hard coded in a fixed BSR table that is conjured to a user equipment by a RAN node. A smaller fixed step size may be suited to report a small volume of buffered uplink traffic and a larger step size may be better suited for a larger volume of buffered uplink traffic. For example, a single BSR index can indicate a buffered traffic range from 240 k bytes to 300 k bytes. With extreme capacity and latency demanding 5G use cases, such as URLLC, VR, AR, etc., such a range may lead to extended scheduling latency and degraded capacity because a BSR comprising an index corresponding to the range 240 k bytes to 300 k bytes does not indicate an exact amount of uplink traffic buffered by the user equipment. Therefore, the RAN node may allocate a more-than-needed amount of uplink resources (e.g., overscheduling) or a less-than-needed amount of uplink resources (e.g., underscheduling) to accommodate transmission by the user equipment to the RAN node of the buffered uplink traffic. Accordingly, the RAN node may perform multiple scheduling operations if the RAN node underschedules uplink resources, which may induce additional scheduling latency, or the RAN node may allocate uplink resources for non-existing uplink traffic if the RAN node overschedule, which may lead to degraded spectral efficiency of the resources scheduled to transmit the uplink traffic. Embodiments disclosed herein may achieve performance benefits of dynamic BSR formulation using multiple static, pre-defined BSR tables that are dynamically selected by a user equipment device (e.g., the user equipment may select a BSR table from multiple based on a volume of buffered traffic and based on which table will likely result in a fewest number of transmissions of BSRs) to generate one or more BSRs indicative of a volume of uplink traffic buffered by the user equipment device.

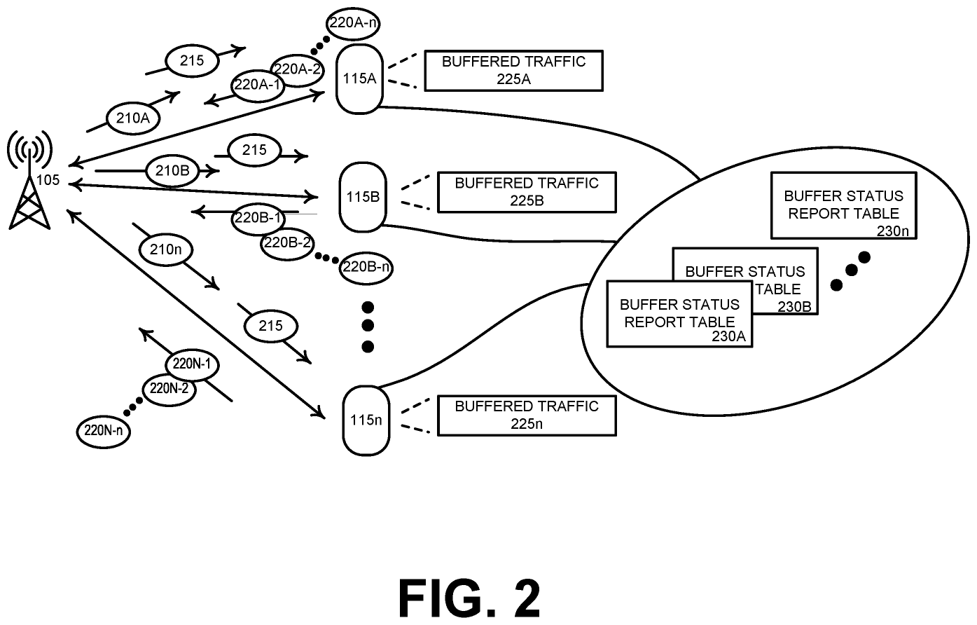

Turning now to FIG. 2, the figure illustrates environment 200. In environment 200, serving radio access network node 105 may transmit to one or more user equipment 115A-115n, one or more buffer status reporting configurations 210. One or more of buffer status reporting configurations 210 may be the same. A buffer status reporting configuration 210 may be specific to a particular user equipment 115A-115n. A user equipment 115 may determine an amount of traffic 225 buffered in a buffer, or memory, corresponding to the user equipment. Based on information indicated in a buffer status reporting configuration(s) 210, the user equipment may determine at least one buffer status report 220, or buffer status report indication, indicative of an amount of traffic 225 buffered by the user equipment. User equipment 115 may transmit one or more buffer status reports 220 to radio access network node 105 to be used thereby to determine uplink resources that may be usable by the user equipment to transmit the buffered traffic. A user equipment 115 may determine a buffer status report 220 based on one or more buffer status report tables 230 indicated in a buffer status report table configuration 215, which may comprise the one or more buffer status report tables 230, configured to the user equipment by radio access network node 105. Configuring of buffer status report tables 230 via buffer status report table configuration 215 may occur before the transmission to user equipment 115 of configuration information 210. A user equipment 115 may determine one or more indices corresponding to one or more traffic volume ranges indicated in a particular one of the one or more buffer status report tables 230 that best fits a volume of traffic 225 buffered by the user equipment for transmission to radio access network node 105. As shown in FIG. 2, each of user equipment 115A-115n are configured with the same tables 230A-230n, but it will be appreciated that different user equipment 115 may be configured with different sets of tables 230.

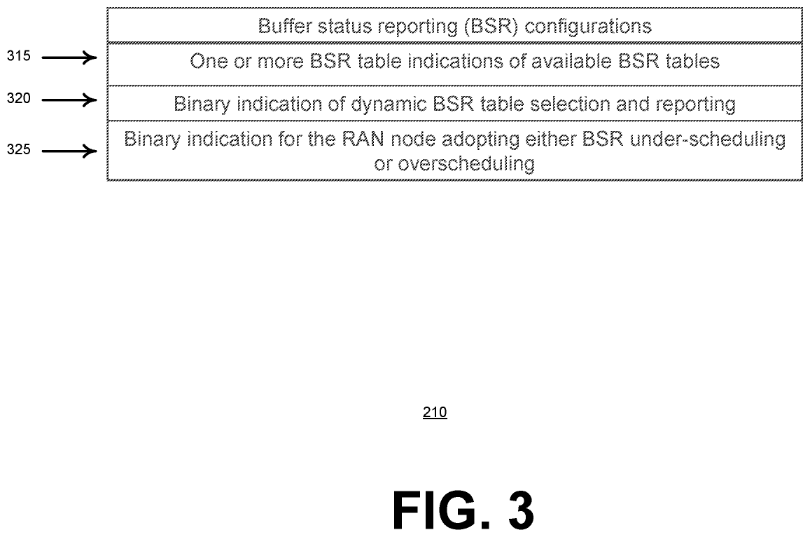

A buffer status report configuration 210 may comprise, as shown in FIG. 3, an available table indication 315 indicative of at least one buffer status report table 230 usable by a user equipment 115 to determine at least one buffer status report 220, or information to include therein. Configuration 210 may comprise a dynamic BSR-reporting-enabled indication 320, which may be a binary indication, indicative that dynamic BSR table selection and reporting is enabled. Indication 320 may be indicative that RAN node 105 has enabled activating of dynamic BSR table selection by a user equipment 115 and that the RAN node expects a user equipment receiving configuration information 210, with BSR table selection being enabled, to determine which of one or more of tables 230, that may be indicated as available to be used (e.g., fewer than all tables 230 may be indicated via indication 315 as available for a specific one or more user equipment devices) to generate one or more BSR(s) 220. Configuration 210 may comprise a scheduling mode indication 325, which may be a binary indication. Indication 325 may be referred to as an underscheduling indication that may be indicative of RAN node 105 operating according to an underscheduling mode and may facilitate indicating to one or more user equipment 115 that serving RAN node 105 has adopted, and is implementing, a resource underscheduling or overscheduling policy. If indication 325 is indicative of overscheduling, user equipment receiving configuration information 210 comprising the scheduling mode indication indicative of overscheduling may determine BSR information to include in a BSR 220 based on a single BSR table, which may be selected by RAN node 105, since overallocating of resources by the RAN node would likely obviate BSR quantization error.

However, if mode indication 325 comprises an underscheduling indication indicative of RAN 105 implementing resource underscheduling, a user equipment 115 may transmit multiple BRSs 220 to indicate volume of buffered uplink traffic in a buffer corresponding to the user equipment until the buffer is cleared of the buffered uplink traffic.

On condition of satisfying conventional BSR reporting conditions at a user equipment (e.g., cither when a delay associated with transmitting of the buffered backets corresponds to a buffering delay criterion being violated or when buffered traffic volume per logical channel group (“LCG”) exceeds a maximum configured traffic volume threshold criterion) and on condition of RAN node 105 having adopted resource underscheduling, for each of configured BSR tables 230A-230n, WTRU/UE 115 may determine a determined number of BSR report transmissions needed to obtain uplink resources to clear the buffered traffic volume. For a given BSR table 230, a UE 115 may determine a number of BSR report transmission(s) needed to clear buffered traffic by determining a first traffic volume index that corresponds to a traffic volume range that encompasses an actual buffered traffic volume and determining a first remaining traffic volume that would remain in the buffer after using resources scheduled in response to a first BSR that indicates the first traffic volume index, by determining a second traffic volume index that corresponds to a traffic volume range that encompasses the first remaining buffered traffic that would remain in the buffer after using resources scheduled in response to a second BSR that indicates the second traffic volume index, and so on until the buffered traffic that caused/triggered buffer status reporting is cleared from the buffer.

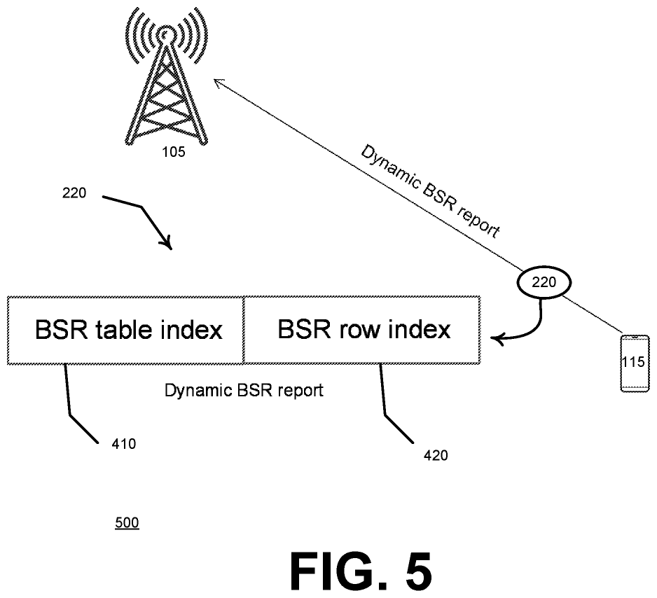

WTRU/UE 115 may select a BSR table (or a combination of more than one BSR table), comprising indices and associated volume ranges indicated therein, corresponding to a lowest determined number of BSR report transmissions that would result in uplink resources being scheduled to clear the total buffered traffic volume. Thus, a user equipment may have the flexibility to select a BSR table (or a combination of BSR tables) that may minimize a number of BSRs that will result in uplink resources being scheduled that will accommodate transmission of buffered traffic and that may thus result in a faster clearance of uplink traffic from the user equipment buffer(s) than if indices from a single BSR table, configured by a RAN node to be used by the user equipment, is used to generate BSRs. A BSR 220 transmitted by a WTRU/UE 115 may comprise, as shown in FIG. 5, a BSR table indication 410 indicative of a BSR table 230 selected to result in the smallest number of BSR transmissions. A BSR 220 transmitted by a WTRU/UE 115 may comprise, as shown in FIG. 5, a BSR index indication 420, which may be referred to as a buffered traffic amount indication, indicative of a range, or row, from a selected BSR table.

Thus, unlike conventional use of a BSR table that is selected by a RAN node, according to embodiments disclosed herein a BSR 220 may comprise a table indication 410 indicative of a BSR table 230, determined/selected by a user equipment 115 based on underscheduling being indicated by RAN 105, and a volume indication 420 indicative of an amount of to-be-transmitted uplink traffic in a buffer corresponding to the user equipment.

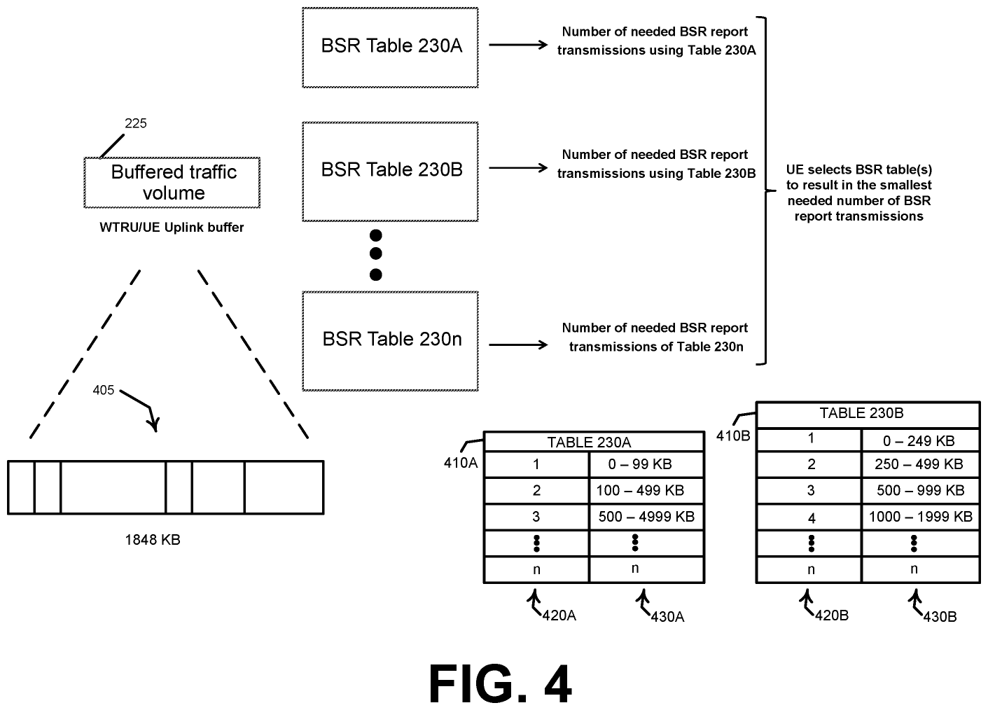

Turning now to FIG. 4, the figure illustrates an example of a user equipment selecting at least one buffer status report table 230A-230n, usable by the user equipment to determine a buffer status report 220, or a buffer status report indication, corresponding to traffic, buffered by the user equipment, to be transmitted toward a serving radio access network node. Buffer status report tables 230A-230n may be configured to the user equipment via a buffer status report table configuration 215 described in reference to FIG. 2. A configuration 210 described in reference to FIGS. 2 and 3 may indicate which table, or tables, of multiple buffer status report tables configured via configuration 215 are to be available for use by the user equipment to determine a buffer status report indication 220.

In an example, buffered traffic 225 may comprise traffic protocol data units 405 (e.g., packets) that total 1,848 Kbytes, which total may be referred to as a subamount. In an embodiment, a user equipment may determine that a radio access network node is underscheduling resources such that a volume range indicated by a buffer status report results in scheduling of uplink resources corresponding to a low number corresponding to a low value of the indicated volume range (e.g., this may be referred to as standard underscheduling). In another embodiment, a user equipment may determine that a radio access network node is under scheduling resources such that a volume range indicated by a buffer status report results in scheduling of uplink resources corresponding 10% less than a low value of the indicated volume range (e.g., this may be referred to as 10% underscheduling). The user equipment may be configured, via an indication 315 in a configuration 210, that BSR tables 230A and 230B are available for use by the user equipment to determine at least one buffer status report corresponding to buffer traffic 405. The user equipment may be configured, via an indication 320 in a configuration 210 that user-equipment-based selection of BSR tables is enabled and via an indication 325 in a configuration 210 that a RAN node serving the user equipment is implementing standard underscheduling.

Based on index 3 in table 230A being associated with a traffic volume range 500 kBytes-4,999 Kbytes, which encompasses buffered traffic amount 405, the user equipment may determine a first number of BSR transmissions needed if table 230A is used by determining that, if a first BSR is transmitted that indicates table 230A in an indication 410A and that indicates index 3 in an indication 420A, a serving RAN node will actually only schedule 500 Kbytes in response to receiving the first BSR. Based on a second BSR that may also indicate table 230A and index 3, which encompasses the remaining subamount, or remainder, of 1,348 Kbytes, the user equipment may anticipate that the RAN node will only schedule 500 Kbytes in response to the second BSR that indicates table 230A and index 3 to accommodate the remaining 1,348 Kbytes that remain after the user equipment transmits the first BSR. Similarly, a third BSR indicating table 230A and index 3 may result in a grant of 500 kBytes to accommodate uplink transmission of the remaining 848 kBytes, after which 348 Kbytes would remain. A BSR indicating table 230A and index 2, which encompasses the remaining 348 kBytes, would result in scheduling of only 100 kBytes. Assuming, as a default or baseline, even with underscheduling, that an index of 1 results in a scheduling of the maximum amount of resources corresponding to the high value of the range corresponding to the index, the user equipment may determine that four more BSRs using table 230A will be needed (three that indicate index 2 that would result in 300 kBytes being scheduled and a fourth that indicates index 1 to result in another 99 kBytes being scheduled). Thus, the user equipment may determine a first transmission number of seven transmissions of BSRs that indicate table 230A are needed to obtain a grant of resources that will accommodate transmission of all 1,848 Kbytes 406.

Based on index 4 in table 230B being associated with a traffic volume range 1,000 Kbytes-1,999 Kbytes, which encompasses buffered traffic amount 405, the user equipment may determine a second number of BSR transmissions needed if table 230B is used by determining that, if a first BSR is transmitted that indicates table 230B in an indication 410B, and that indicates index 4 in an indication 420B, a serving RAN node will actually only schedule 1,000 Kbytes in response to receiving a first BSR indicating table 230B. Based on a second BSR that may also indicate table 230B and index 3, which encompasses the remaining subamount, or remainder, of 848 Kbytes, the user equipment may anticipate that the RAN node will only schedule 500 Kbytes in response to the second BSR that indicates table 230B and index 3 to accommodate the remaining 848 Kbytes that remain after the user equipment transmits 1,000 Kbytes of traffic 405 based on standard underscheduling of resource responsive to the first BSR. Based on a third BSR that may also indicate table 230B and index 2, which encompasses the remaining subamount, or remainder, of 348 Kbytes, the user equipment may anticipate that the RAN node will only schedule 250 Kbytes in response to the third BSR that indicates table 230B and index 2 to accommodate the remaining 348 Kbytes that remain after the user equipment transmits 500 Kbytes of traffic 405 based on standard underscheduling of resources responsive to the second BSR. Assuming transmission of a BSR indicating table 230B and an index of 1 results in a scheduling of the maximum amount of resources corresponding to the high value of the range corresponding to the index, the user equipment may determine that one more BSR using table 230B and indicating index I will be needed because a serving RAN node would likely schedule 248 kBytes in response to a BSR that indicates table 230B and index 1. Thus, the user equipment may determine a second transmission number of four transmissions of BSRs indicating table 230B are needed to obtain a grant of resources that will accommodate transmission of all 1,851 Kbytes 406. Accordingly, in the example described in reference to FIG. 4, a user equipment that is configured with tables 230A and 230B being available, as indicated by an indication 315 in a configuration 210, to use to generate BSRs, may select BSR table 230B because table 230B corresponds to a determined lowest transmission number that is the lower of the determined first transmission number (e.g., seven BSR transmissions) or the determined second transmission number (e.g., four BSR transmission).

In an embodiment, the user equipment may determine to use BSR table 230B for a first BSR report transmission (based on standard underscheduling) that indicates table 230B and index 4 (to result in a scheduling of 1,000 kBytes), a second BSR indicating table 230B and index 3 (to result in a scheduling of 500 kBytes), a third BSR indicating table 230B and index 2 (to result in a scheduling of 250 kBytes), and a fourth BSR indicating table 230A and index 1, which would result in a determined number of BSR transmissions being four, but would result in resources usable to transmit 1 byte of buffered traffic being wasted as compared to 151 kBytes potentially being wasted if table 230B is exclusively used for all four BSRs.

Turning now to FIG. 5, the figure illustrates an example buffer status report 220 that may be transmitted by a user equipment to a serving radio access network node. Buffer status report indication 220 may comprise a buffer status report table indication 410, and a buffer status report index indication 420, which may be referred to as a buffered traffic volume range index. Table indication 410 may be indicative of a table 230A-230n, configured via a table configuration 215, that comprises a range that the user equipment determines best fits an amount of traffic, buffered by the user equipment, to be transmitted to the serving radio access network node. The traffic volume range index/indication 420 may be indicative of a traffic volume range, contained in the table 230 indicated by table indication 410. Thus, based on information indicated by BSR 220, which may be referred to as a buffer status report indication, radio access network node 105 receiving the BSR may determine one or more uplink resource(s) to schedule for use by user equipment 115 to transmit the buffered traffic to the radio access network node. Because multiple buffer status report tables 230A-230n may have been configured to the user equipment to be usable by the user equipment to determine a range and a range index corresponding thereto, BSR 220 may comprise table indication 410 to facilitate radio access network node 105 determining with which of tables 230A-230n, which may have been configured to be usable by the user equipment, a traffic volume range corresponding to index indication 420 is associated.

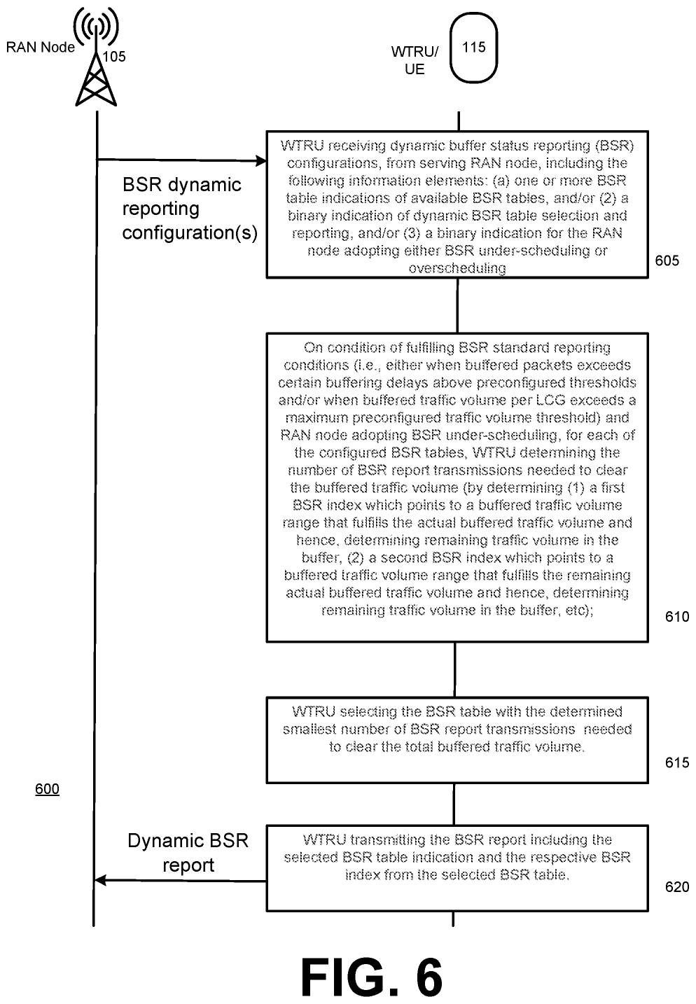

Turning now to FIG. 6, the figure illustrates a timing diagram of an example method 600 to use, by UE 115, multiple buffer status reporting tables, configured by serving radio access network node 105, to report to the serving radio access network node a buffer status report indicative of traffic, buffered by the user equipment, to be transmitted toward the serving radio access network node. At act 605 RAN node 105 may transmit to UE/WTRU 115 a buffer status reporting configuration, such as configuration 210 described in reference to FIG. 2. The buffer status reporting configuration may comprise: an available table indication indicative of one or more available BSR tables; a binary indication of dynamic BSR table selection and reporting being enabled; or a binary indication indicative of the RAN node adopting either BSR under-scheduling or overscheduling. On condition of satisfying a conventional BSR reporting condition (e.g., either when delay corresponding to buffered packets exceeds a configured buffering delay criterion or when buffered traffic volume per logical channel group exceeds a maximum preconfigured traffic volume threshold) and on condition of the configuration received at act 605 indicating that RAN node 105 has adopting, or is implementing, resource underscheduling in response to receiving BSR tables (e.g., table(s) 230 configured via table configuration 215), WTRU/UE 115 may determine at act 610 a number of BSR report transmissions that would likely clear the buffered traffic volume from a buffer corresponding to UE 115. UE 115 may determine a number of BSR transmissions by determining a first BSR table and index which points to a buffered traffic volume range that may clear most of the actual buffered traffic volume and by determining a remaining traffic volume in the buffer that would be left after resources scheduled according to the first BSR, or one or more preceding BSRs, are used, by determining a second BSR table and index which points to a buffered traffic volume range that would clear the determined remaining buffered traffic volume, and determining a third BSR, a fourth BSR, and so on according to similar methodology, such that BSR tables and indices included therein may be determined to facilitate RAN 105 scheduling uplink resource according to the first, second, and additional indexes, if any, that will likely clear the buffer of buffered traffic with a minimum of BSR transmissions from UE 115 to RAN node 105.

At act 615, WTRU/UE 115 may determine a BSR table with the determined smallest number of BSR report transmissions that would likely result in scheduling of resources that would clear the total buffered traffic volume. The smallest number of transmissions needed may be determined based on determining a first index that corresponds to a volume range encompasses the total buffered traffic, determining a second index that encompasses a reminder of traffic, and so on until the indexes determined by user equipment 115 correspond to enough scheduled resources that would result in clearing of buffered traffic while minimizing resource volume being requested, via the indexes, from RAN 105. In an embodiment, the different indexes may correspond to different tables 230 configured via configuration 215. Thus, at act 620, WTRU/UE 115 may transmit one or more buffer status reports 220, which may be referred to as a buffer status report indications, that may be indicative of the indexes and indicative of tables associated with the indexes. In an embodiment, the different indexes may correspond to the same table 230, or different table 230, configured via configuration 215, and thus at act 620, WTRU/UE 115 may transmit one or more buffer status reports each being indicative of a traffic volume range index and a table associated with the traffic volume index.

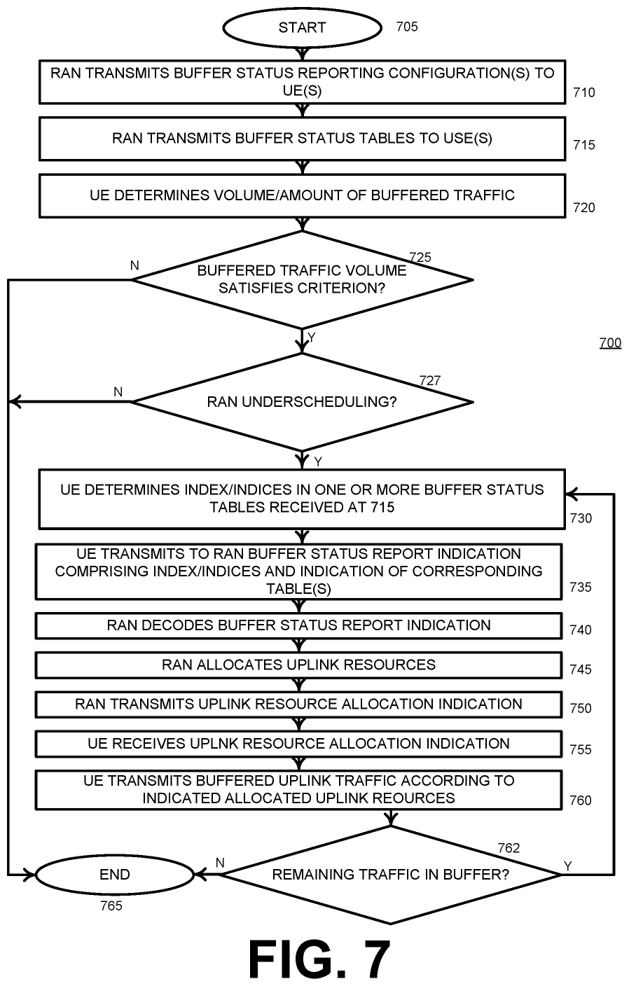

Turning now to FIG. 7, the figure illustrates a flow diagram of a method 800 to configure a UE to use one or more buffer status report tables to report to a serving radio access network node an amount of traffic, buffered by the user equipment, to be transmitted to the serving radio access network node, to facilitate the radio access network node allocating resources that may be usable by the user equipment to transmit the buffered traffic to the radio access network node. Method 700 begins at act 705. At act 710, the radio access network node may transmit a buffer status reporting configuration to one or more user equipment devices. The buffer status reporting configuration may be usable by more than one user equipment, may be device-specific relative to a particular user equipment, or may be group-specific relative to a set of particular user equipment. One user equipment may receive a different buffer status reporting configuration than another user equipment. At act 715, the radio access network node may transmit one or more buffer status report table(s) in one or more buffer status report table configuration(s) to one or more user equipment. A buffer status report table configuration may be device-specific or group-specific. At act 720, the user equipment may determine a volume, or amount, of uplink traffic buffered in a buffer corresponding to the user equipment. At act 725, the user equipment may determine whether the uplink traffic buffered in the buffer satisfies a buffer status reporting criterion, which may be a conventional buffer status reporting criterion such as a latency criterion or a volume criterion. If a determination is made at act 725 that buffered uplink traffic does not satisfy a conventional buffer status report criterion such that a buffer status report is generated or transmitted to the radio access network node, method 700 may advance to act 765 and end.

Returning to description of act 725, if a determination is made that uplink traffic buffered in a buffer corresponding to the user equipment satisfies a conventional buffer status reporting criterion, method 700 may advance to act 727. At act 727, a determination may be made whether the radio access network node is implementing underscheduling, with respect to buffered uplink traffic, that may be indicated in a buffer status reporting configuration. If a determination is made at act 727 that the radio access network node is not implementing uplink resource underscheduling in response to buffer status reports, method 700 may advance to act 765 and end. If, however, a determination is made at act 727 that the radio access network node is implementing underscheduling of uplink resources in response to receiving buffer status reports, method 700 may advance to act 730. A determination made at act 727 may be based on a underscheduling indication, indicative of underscheduling by the radio access network node, such as an indication 325 shown in FIG. 3, that may be included in, or indicated, by the buffer status reporting configuration transmitted at act 710.

If a determination is made at act 727 that the radio access network node is implementing underscheduling, at act 730 the user equipment may determine one or more indices, and one or more corresponding buffer status report tables, which may have been received at act 715 and which may have been indicated, in the buffer status reporting configuration transmitted at act 710, as usable by the user equipment, or as activated for use by the user equipment, to generate buffer status reports. It will be appreciated that act 715 is shown in FIG. 7 as occurring after act 710 but that actions indicated by block 715 in the figure may be performed before actions indicated by block 710. It will be appreciated that one radio access network node may transmit the reporting configuration at act 710 and a different radio access network node may transmit/configure buffer status report tables, for example tables 230, to the user equipment.

The one or more indices corresponding to the one or more buffer status report tables determined at act 730 may be determined to minimize a number of buffer status reports transmitted by the user equipment to the radio access network node to indicate uplink traffic buffered by the user equipment. The user equipment may determine a first number of first indices, and thus a first number of first buffer status reports, that may be needed to report the amount of buffered traffic determined at act 720 according to a first buffer status report table and the user equipment may determine a second number of second indices, and thus second buffer status reports, that may be needed to report the amount of buffered traffic determined at act 720 according to a second buffer status report table. The user equipment may determine either the first buffer status report table or the second buffer status report table, corresponding to the lowest of the first number of indices or the second number of indices, to use for reporting, in one or more buffer status reports, one or more traffic volume indices corresponding to one or more traffic volume ranges in the selected report table. It will be appreciated that in an embodiment, at act 730 the user equipment may determine more than one buffer status report table such that a number of indices, and thus a corresponding number of buffer status reports needed to report the amount of buffer traffic determined at act 720, is minimized.

The user equipment may generate a buffer status report that comprises a volume range index, or an indication of a volume range index, such as index 420 shown in FIG. 5, and a buffer status report table index, or an indication of a buffer status report table, such as table index 410 shown in FIG. 5, corresponding to the traffic volume index. Accordingly, in addition to a traffic volume range index 420, or an indication/identifier indicative of a traffic volume range index, associated with a volume range in a selected buffer status report table, the buffer status report may comprise a table, such as, for example, index 410 shown in FIG. 5. Thus, user equipment may select from one or more configured buffer status report tables, available to be used to generate buffer status reports that may be transmitted to the radio access network node, wherein each buffer status report includes a traffic volume range index and a table index indicative of a table that includes the traffic volume range index indicated in the buffer status report. At act 735, the user equipment may transmit to the radio access network node a buffer status report that comprises the traffic volume range index and an identifier of a buffer status report table corresponding to the indicated traffic volume range index.

At act 740, the radio access network node may decode the buffer status report indication, or buffer status report, transmitted by the user equipment at act 735, and at act 745 the radio access network node may allocate, or schedule, uplink resources to accommodate a volume of traffic indicated by the traffic volume range index in the buffer status report transmitted at act 735. At act 750, the radio access network node may transmit to the user equipment an uplink resource allocation indication indicative of the uplink resources allocated, or scheduled, at act 745. At act 755, the user equipment may receive the indication of allocated, or scheduled, uplink resources transmitted at act 750, and at act 760 the user equipment may transmit a subamount of the amount of buffered uplink traffic determined at act 720. The subamount of traffic transmitted at act 760 may comprise all of the traffic determined at act 720 or a portion of the traffic determined at 720. The subamount of traffic transmitted at act 760 may be a remainder of the traffic amount determined at 720 that remains in a buffer corresponding to the user equipment after a previous scheduling of uplink resources and transmitting of a subamount of the resources according thereto may have been performed at a previous iteration of 760. After transmitting, at act 760, the subamount of buffered traffic, at act 762 the user equipment may determine whether a remainder of traffic determined at act 720 remains in the buffer. If a determination is made at act 762 that some of, or a subamount of, traffic determined at act 720 remains in the buffer, method 700 may return to act 730 and may determine another index, from the one or more tables determined at act 730, to use to transmit at act 735 another buffer status report indicative of the remainder/subamount. If a determination is made at act 762 that the buffer has been cleared of the traffic determined at act 720, method 700 advances to act 765 and ends.

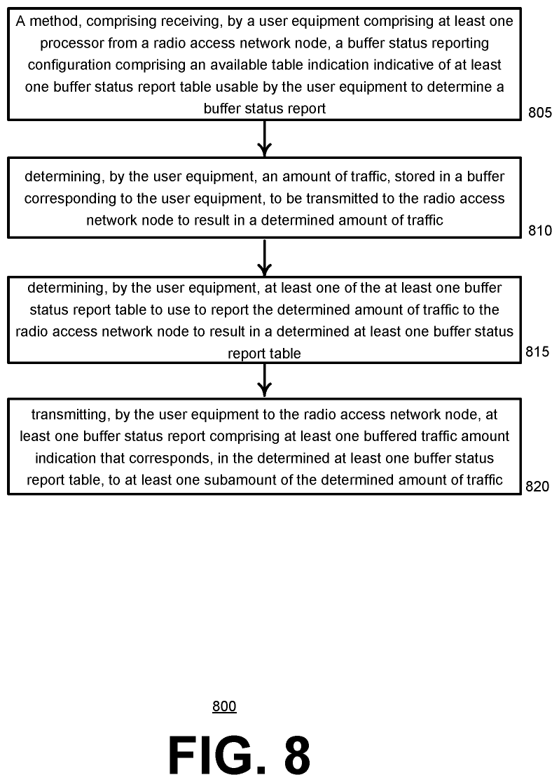

Turning now to FIG. 8, the figure illustrates an example embodiment method 800 comprising at block 805 receiving, by a user equipment comprising at least one processor from a radio access network node, a buffer status reporting configuration comprising an available table indication indicative of at least one buffer status report table usable by the user equipment to determine a buffer status report; at block 810 determining, by the user equipment, an amount of traffic, stored in a buffer corresponding to the user equipment, to be transmitted to the radio access network node to result in a determined amount of traffic; at block 815 determining, by the user equipment, at least one of the at least one buffer status report table to use to report the determined amount of traffic to the radio access network node to result in a determined at least one buffer status report table; and at block 820 transmitting, by the user equipment to the radio access network node, at least one buffer status report comprising at least one buffered traffic amount indication that corresponds, in the determined at least one buffer status report table, to at least one subamount of the determined amount of traffic.

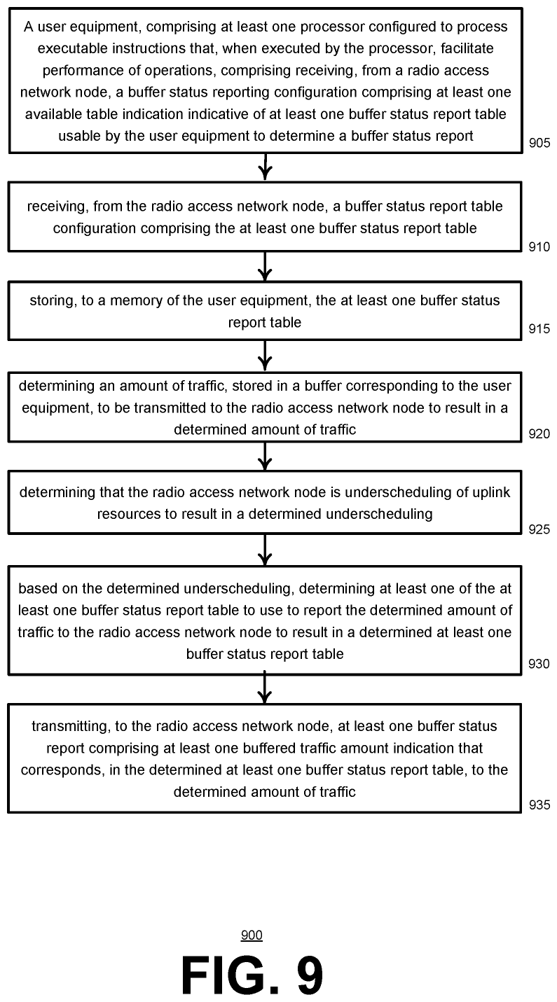

Turning now to FIG. 9, the figure illustrates an example user equipment 900, comprising at block 905 at least one processor configured to process executable instructions that, when executed by the processor, facilitate performance of operations, comprising receiving, from a radio access network node, a buffer status reporting configuration comprising at least one available table indication indicative of at least one buffer status report table usable by the user equipment to determine a buffer status report; at block 910 receiving, from the radio access network node, a buffer status report table configuration comprising the at least one buffer status report table; at block 915 storing, to a memory of the user equipment, the at least one buffer status report table; at block 920 determining an amount of traffic, stored in a buffer corresponding to the user equipment, to be transmitted to the radio access network node to result in a determined amount of traffic; at block 925 determining that the radio access network node is underscheduling of uplink resources to result in a determined underscheduling; at block 930 based on the determined underscheduling, determining at least one of the at least one buffer status report table to use to report the determined amount of traffic to the radio access network node to result in a determined at least one buffer status report table; and at block 935 transmitting, to the radio access network node, at least one buffer status report comprising at least one buffered traffic amount indication that corresponds, in the determined at least one buffer status report table, to the determined amount of traffic.

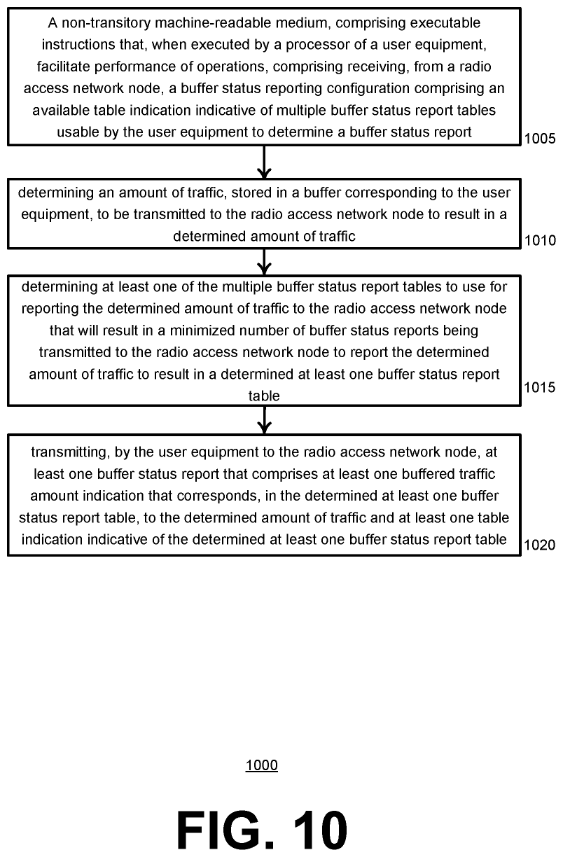

Turning now to FIG. 10, the figure illustrates a non-transitory machine-readable medium 1000 comprising at block 1005 executable instructions that, when executed by a processor of a user equipment, facilitate performance of operations, comprising receiving, from a radio access network node, a buffer status reporting configuration comprising an available table indication indicative of multiple buffer status report tables usable by the user equipment to determine a buffer status report; at block 1010 determining an amount of traffic, stored in a buffer corresponding to the user equipment, to be transmitted to the radio access network node to result in a determined amount of traffic; at block 1015 determining at least one of the multiple buffer status report tables to use for reporting the determined amount of traffic to the radio access network node that will result in a minimized number of buffer status reports being transmitted to the radio access network node to report the determined amount of traffic to result in a determined at least one buffer status report table; and at block 1020 transmitting, by the user equipment to the radio access network node, at least one buffer status report that comprises at least one buffered traffic amount indication that corresponds, in the determined at least one buffer status report table, to the determined amount of traffic and at least one table indication indicative of the determined at least one buffer status report table.

In order to provide additional context for various embodiments described herein, FIG. 11 and the following discussion are intended to provide a brief, general description of a suitable computing environment 1100 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors and may include a cache memory. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

Computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid-state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can comprise a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

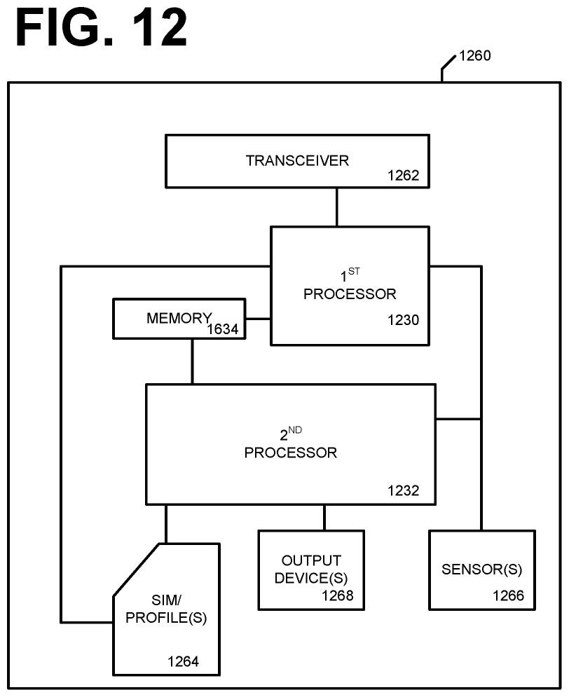

Turning to FIG. 12, the figure illustrates a block diagram of an example UE 1260. UE 1260 may comprise a smart phone, a wireless tablet, a laptop computer with wireless capability, a wearable device, a machine device that may facilitate vehicle telematics, a tracking device, remote sensing devices, and the like. UE 1260 comprises a first processor 1230, a second processor 1232, and a shared memory 1234. UE 1260 includes radio front end circuitry 1262, which may be referred to herein as a transceiver, but is understood to typically include transceiver circuitry, separate filters, and separate antennas for facilitating transmission and receiving of signals over a wireless link, such as one or more wireless links 125, 135, and 137 shown in FIG. 1. Furthermore, transceiver 1262 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 12, UE 1260 may also include a SIM 1264, or a SIM profile, which may comprise information stored in a memory (memory 34 or a separate memory portion), for facilitating wireless communication with RAN 105 or core network 130 shown in FIG. 1. FIG. 12 shows SIM 1264 as a single component in the shape of a conventional SIM card, but it will be appreciated that SIM 1264 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1264 and another device, which may be a component of RAN 105 or core network 130 shown in FIG. 1). A SIM profile 1264 may also comprise identifying information that is unique to the SIM, or SIM profile, such as, for example, an International Mobile Subscriber Identity (“IMSI”) or information that may make up an IMSI.

SIM 1264 is shown coupled to both the first processor portion 1230 and the second processor portion 1232. Such an implementation may provide an advantage that first processor portion 1230 may not need to request or receive information or data from SIM 1264 that second processor 1232 may request, thus eliminating the use of the first processor acting as a ‘go-between’ when the second processor uses information from the SIM in performing its functions and in executing applications. First processor 1230, which may be a modem processor or a baseband processor, is shown smaller than processor 1232, which may be a more sophisticated application processor, to visually indicate the relative levels of sophistication (i.e., processing capability and performance) and corresponding relative levels of operating power consumption levels between the two processor portions. Keeping the second processor portion 1232 asleep/inactive/in a low power state when UE 1260 does not need it for executing applications and processing data related to an application provides an advantage of reducing power consumption when the UE only needs to use the first processor portion 1230 while in listening mode for monitoring routine configured bearer management and mobility management/maintenance procedures, or for monitoring search spaces that the UE has been configured to monitor while the second processor portion remains inactive/asleep.

UE 1260 may also include sensors 1266, such as, for example, temperature sensors, accelerometers, gyroscopes, barometers, moisture sensors, and the like that may provide signals to the first processor 1230 or second processor 1232. Output devices 1268 may comprise, for example, one or more visual displays (e.g., computer monitors, VR appliances, and the like), acoustic transducers, such as speakers or microphones, vibration components, and the like. Output devices 1268 may comprise software that interfaces with output devices, for example, visual displays, speakers, microphones, touch sensation devices, smell or taste devices, and the like, that are external to UE 1260.

The following glossary of terms given in Table I may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| WTRU | Wireless transmit receive unit |
| QCI | QoS Class Identifiers |
| BSR | Buffer status report |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by a user equipment comprising at least one processor from a radio access network node, a buffer status reporting configuration comprising an available table indication indicative of at least one buffer status report table usable by the user equipment to determine a buffer status report;
determining, by the user equipment, an amount of traffic, stored in a buffer corresponding to the user equipment, to be transmitted to the radio access network node to result in a determined amount of traffic;
determining, by the user equipment, at least one of the at least one buffer status report table to use to report the determined amount of traffic to the radio access network node to result in a determined at least one buffer status report table; and
transmitting, by the user equipment to the radio access network node, at least one buffer status report comprising at least one buffered traffic amount indication that corresponds, in the determined at least one buffer status report table, to at least one subamount of the determined amount of traffic.

2. The method of claim 1, further comprising:
receiving, by the user equipment from the radio access network node, a buffer status report table configuration comprising the at least one buffer status report table; and
storing, by the user equipment to a memory corresponding to the user equipment, the at least one buffer status report table.

3. The method of claim 2, wherein the buffer status report table configuration comprises multiple buffer status report tables and wherein the available table indication is indicative of less than all of the multiple buffer status report tables.

4. The method of claim 3, wherein the available table indication is indicative of a first buffer status report table of the multiple buffer status report tables and a second buffer status report table of the multiple buffer status report tables, the method further comprising:
determining that the radio access network node is implementing an underscheduling of uplink resources in response to receiving buffer status reports to result in a determined underscheduling,
wherein the determining of the at least one buffer status report table comprises:
based on the determined underscheduling, determining a first transmission number corresponding to use of the first buffer status report table to transmit at least one of the at least one buffer status report comprising the at least one buffered traffic amount indication that corresponds to the at least one subamount of the determined amount of traffic to result in a determined first transmission number;
based on the determined underscheduling, determining a second transmission number corresponding to use of the second buffer status report table to transmit at least one of the at least one buffer status report comprising the at least one buffered traffic amount indication that corresponds to the at least one subamount of the determined amount of traffic to result in a determined second transmission number; and
determining a lower of the determined first transmission number or the determined second transmission number to result in a determined lowest transmission number,
wherein the determined at least one buffer status report table is the first buffer status report table or the second buffer status report table that corresponds to the determined lowest transmission number.

5. The method of claim 4, wherein the determining of the first transmission number further comprises:
determining, from the first buffer status report table, a first traffic volume range index associated with a first traffic volume range that minimizes, based on the underscheduling, a first subamount remainder of the at least one subamount of the determined amount of traffic;
determining at least one first subamount remainder transmission number corresponding to use of the first buffer status report table to transmit at least one of the at least one buffer status report comprising the at least one buffered traffic amount indication that corresponds to the first subamount remainder of the determined amount of traffic to result in a determined first subamount transmission number, wherein the first transmission number equals one plus the determined first subamount transmission number, and
wherein determining the second transmission number further comprises:
determining, from the second buffer status report table, a second traffic volume range index associated with a second traffic volume range that minimizes, based on the underscheduling, a second subamount remainder of the at least one subamount of the determined amount of traffic; and
determining at least one second subamount remainder transmission number corresponding to use of the second buffer status report table to transmit at least one of the at least one buffer status report comprising the at least one buffered traffic amount indication that corresponds to the second subamount remainder of the determined amount of traffic to result in a determined second subamount transmission number, wherein the second transmission number equals one plus the determined second subamount transmission number.

6. The method of claim 4, wherein the buffer status reporting configuration further comprises an underscheduling indication indicative of the underscheduling.

7. The method of claim 4, further comprising:
based on a previous uplink resource grant of at least one uplink resource, granted by the radio access network node in response to receiving at least one previous buffer status report transmitted by the user equipment before the transmitting of the at least one buffer status report, determining, by the user equipment, the underscheduling.

8. The method of claim 1, wherein the at least one buffer status report further comprises at least one table indication indicative of the determined at least one buffer status report table.

9. The method of claim 1, wherein the at least one subamount of the determined amount of traffic equals the determined amount of traffic.

10. The method of claim 1, further comprising:
receiving, from the radio access network node, an activated table indication indicative of at least one of the at least one buffer status report table indicated by the available table indication.

11. A user equipment, comprising:
at least one processor configured to process executable instructions that, when executed by the processor, facilitate performance of operations, comprising:
receiving, from a radio access network node, a buffer status reporting configuration comprising at least one available table indication indicative of at least one buffer status report table usable by the user equipment to determine a buffer status report;
receiving, from the radio access network node, a buffer status report table configuration comprising the at least one buffer status report table;
storing, to a memory of the user equipment, the at least one buffer status report table;
determining an amount of traffic, stored in a buffer corresponding to the user equipment, to be transmitted to the radio access network node to result in a determined amount of traffic;
determining that the radio access network node is underscheduling of uplink resources to result in a determined underscheduling;
based on the determined underscheduling, determining at least one of the at least one buffer status report table to use to report the determined amount of traffic to the radio access network node to result in a determined at least one buffer status report table; and
transmitting, to the radio access network node, at least one buffer status report comprising at least one buffered traffic amount indication that corresponds, in the determined at least one buffer status report table, to the determined amount of traffic.

12. The user equipment of claim 11, wherein the at least one buffer status report further comprises at least one table indication indicative of the determined at least one buffer status report table.

13. The user equipment of claim 11, wherein the at least one buffered traffic amount indication that corresponds to the determined amount of traffic comprises a first buffered traffic amount indication corresponding to a first traffic volume range in the determined at least one buffer status report table, wherein the at least one buffered traffic amount indication that corresponds to the determined amount of traffic further comprises a second buffered traffic amount indication corresponding to a second traffic volume range in the determined at least one buffer status report table, wherein the at least one buffer status report comprises a first buffer status report that comprises the first buffered traffic amount indication, and wherein the at least one buffer status report further comprises a second buffer status report that comprises the second buffered traffic amount indication.

14. The user equipment of claim 13, wherein the first traffic volume range corresponds to a determined first buffer status report table of the at least one buffer status report table, and wherein the second traffic volume range corresponds to a determined second buffer status report table of the at least one buffer status report table.

15. The user equipment of claim 14, wherein the at least one buffer status report comprises a first buffer status report comprising a first determined table indication indicative of the determined first buffer status report table, and wherein the at least one buffer status report further comprises a second buffer status report comprising a second determined table indication indicative of the determined second buffer status report table.

16. The user equipment of claim 11, wherein the at least one buffer status report table comprises multiple buffer status report tables, and wherein the determining of the at least one of the at least one buffer status report table comprises:
determining that use of the determined at least one buffer status report table corresponds to fewer transmissions of buffer status reports than use of other of the multiple buffer status report tables.

17. A non-transitory machine-readable medium, comprising executable instructions that, when executed by a processor of a user equipment, facilitate performance of operations, comprising:
receiving, from a radio access network node, a buffer status reporting configuration comprising an available table indication indicative of multiple buffer status report tables usable by the user equipment to determine a buffer status report;
determining an amount of traffic, stored in a buffer corresponding to the user equipment, to be transmitted to the radio access network node to result in a determined amount of traffic;
determining at least one of the multiple buffer status report tables to use for reporting the determined amount of traffic to the radio access network node that will result in a minimized number of buffer status reports being transmitted to the radio access network node to report the determined amount of traffic to result in a determined at least one buffer status report table; and
transmitting, by the user equipment to the radio access network node, at least one buffer status report that comprises at least one buffered traffic amount indication that corresponds, in the determined at least one buffer status report table, to the determined amount of traffic and at least one table indication indicative of the determined at least one buffer status report table.

18. The non-transitory machine-readable medium of claim 17, wherein, to determine the at least one of the multiple buffer status report tables that corresponds to the minimized number of buffer status reports being transmitted to the radio access network node, the operations further comprise:
for each table of the multiple buffer status report tables:
determining an initial traffic volume range that corresponds to a first lowest-traffic-volume-range that encompasses the determined amount of traffic to result in a determined initial lowest-traffic-volume-range;
based on uplink resource underscheduling by the radio access network node, determining a remainder amount of traffic;
determining at least one subsequent traffic volume range that corresponds to a second lowest-traffic-volume-range that encompasses the remainder amount of traffic to result in a determined at least one subsequent lowest-traffic-volume-range;
determining a number of traffic volume ranges based on the determined initial lowest-traffic-volume-range and the determined at least one subsequent lowest-traffic-volume-range; and
determining a lowest number of traffic volume ranges with respect to the multiple buffer status report tables.

19. The non-transitory machine-readable medium of claim 18, wherein the at least one buffered traffic amount indication comprises an initial buffered traffic amount indication indicative of the determined initial lowest traffic volume range, or wherein the at least one buffered traffic amount indication comprises a subsequent buffered traffic amount indication indicative of the determined at least one subsequent lowest traffic volume range.

20. The non-transitory machine-readable medium of claim 19, wherein the at least one buffer status report comprises a first buffer status report comprising the initial buffered traffic amount indication, wherein the at least one table indication is indicative of a first buffer status report table, of the multiple buffer status report tables, that comprises the determined initial lowest traffic volume range, wherein the at least one buffer status report further comprises a second buffer status report comprising the subsequent buffered traffic amount indication, and wherein the at least one table indication is indicative of a second buffer status report table of the multiple buffer status report tables that comprises the determined at least one subsequent lowest traffic volume range.
